(19) United States
(12) Patent Application Publication
(10) Pub. No.: US 2019/0347038 A1
(43) Pub. Date: Nov. 14, 2019

(54) DATA STORAGE APPARATUS AND SYSTEM INFORMATION PROGRAMMING METHOD

(71) Applicant: SILICON MOTION, INC., Zhubei City (TW)

(72) Inventors: Ching-Ke CHEN, Zhubei City (TW); Po-Sheng CHOU, Zhubei City (TW); Yang-Chih SHEN, Taoyuan City (TW)

(73) Assignee: SILICON MOTION, INC., Zhubei City (TW)

(21) Appl. No.: 16/410,660

(22) Filed: May 13, 2019

(30) Foreign Application Priority Data
May 14, 2018 (TW) 107116350

(51) Int. Cl. G06F 3/06

(52) U.S. Cl. CPC G06F 3/0658; G06F 3/0679; G06F 3/0644; G06F 3/064

(57) ABSTRACT

The disclosure discloses a data storage apparatus and a system information programming method. The data storage apparatus includes a non-volatile memory and a memory controller. The non-volatile memory includes a logical unit number (LUN). The LUN includes a number of planes. Each plane includes a number of blocks. Each block includes a number of pages. The memory controller is configured to select a number of member blocks from the blocks on each of the planes of the LUN to form a big block, divide the big block into a plurality of small blocks according to a plane amount parameter, group the pages on different planes of each small block to form a plurality of big pages according to a page or plane orientation, and write a system information to one of the big pages by performing an inter-leaving programming process.

This application claims the benefit of Taiwan application Ser. No. 107116350, filed May 14, 2018, the subject matter of which is incorporated herein by reference.

### BACKGROUND OF THE DISCLOSURE

### Field of the Disclosure

The disclosure relates in general to a data storage apparatus and a system information programming method.

### Description of the Related Art

Along with the advance in the manufacturing technology of memory, the unit storage capacity of the memory is getting larger and larger. In recent years, the internal structure of the memory is directed towards the trend of increasing the storage capacity of each block but decreasing the total amount of blocks. In other words, the memory is directed towards the trend of “less blocks but larger block capacity”. Under such configuration, if no changes are made to the operation, during the process of writing data with a small data amount, too many dummy data will be written to the memory and cause unnecessary waste of storage space.

### SUMMARY OF THE DISCLOSURE

The disclosure is directed to a data storage apparatus and a system information programming method thereof.

According to one embodiment of the disclosure, a data storage apparatus, includes a non-volatile memory and the memory controller. The non-volatile memory includes a logical unit number (LUN). The LUN includes a number of planes. Each plane includes a number of blocks. Each block includes a number of pages. The memory controller is coupled to the memory and configured to select a number of member blocks from the blocks on each of the planes of the LUN to form a big block, divide the big block into a number of small blocks according to a plane amount parameter, group the pages on different planes of each small block to form a number of big pages according to a page or plane orientation, and write a system information to one of the big pages by performing an inter-leaving programming process.

According to another embodiment of the disclosure, a data storage apparatus including a non-volatile memory and a memory controller is disclosed. The non-volatile memory includes a number of logical unit numbers (LUNs). Each LUN includes a number of planes. Each plane includes a number of blocks. Each block includes a number of pages. The memory controller is coupled to the memory and configured to select a number of member blocks from the blocks on each plane of the LUNs to form a super block, divide the super block into a number of small blocks according to a plane amount parameter, group the pages on different planes of each small block to form a number of big pages according to a page or plane orientation, and write a system information to one of the big pages by performing an inter-leaving programming process.

According to an alternate embodiment of the disclosure, a system information programming method for a data storage apparatus is disclosed. The programming method includes respectively selecting a member block from a number of blocks on each plane of the LUN of the non-volatile memory to form a big block; dividing the big block into a number of small blocks according to a plane amount parameter; grouping the pages on different planes of each small block to form a number of big pages according to a page or plane orientation; and writing a system information to one of the big pages by performing an inter-leaving programming process.

According to another alternate embodiment of the disclosure, a system information programming method for a data storage apparatus is disclosed. The programming method includes respectively selecting a member block from a number of blocks on each plane of a number of logical unit numbers (LUNs) of the non-volatile memory to form a super block; dividing the super block into a number of small blocks according to a plane amount parameter; group the pages on different planes of each small block to form a number of big pages according to a page or plane orientation; and writing a system information to one of the big pages by performing an inter-leaving programming process.

The data storage apparatus and the system information programming method of the disclosure effectively avoid writing too many dummy data to the non-volatile memory, hence increasing the use efficiency of internal storage space of the non-volatile memory.

The above and other aspects of the disclosure will become better understood with regards to the following detailed description of the preferred but non-limiting embodiment(s). The following description is made with reference to the accompanying drawings.

### BRIEF DESCRIPTION OF THE DRAWINGS

FIG. 1 is a block diagram of a data storage apparatus according to an embodiment of the disclosure.

FIG. 2A is a flowchart of a system information programming method according to an embodiment of the disclosure.

FIG. 2B is a schematic diagram of the composition of a big block and big pages according to an embodiment of the disclosure.

FIG. 2C is a schematic diagram of a big block composed of big pages according to an embodiment of the disclosure.

FIG. 2D is a schematic diagram of the composition of a big block and big pages according to another embodiment of the disclosure.

FIG. 3A is a block diagram of a data storage apparatus according to another embodiment of the disclosure.

FIG. 3B is a flowchart of a system information programming method according to another embodiment of the disclosure.

### DETAILED DESCRIPTION OF THE DISCLOSURE

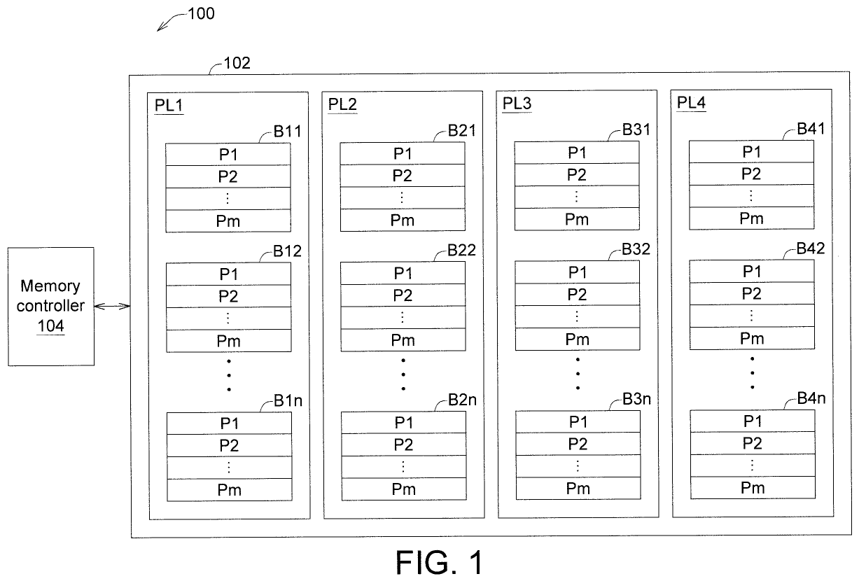

Referring to FIG. 1, a block diagram of a data storage apparatus according to an embodiment of the disclosure is shown. The data storage apparatus 100 mainly includes a non-volatile memory 102 and a memory controller 104, and may further include a volatile memory to temporarily store the user data or the firmware or the mapping table required for the operation of the memory controller 104. The memory controller 104 is coupled to the non-volatile memory 102, and can perform the system information programming method disclosed in the embodiments of the disclosure.

The non-volatile memory 102 can be a NAND flash memory. The memory controller 104 can be implemented as one or more than one control chip capable of transceiving data and instructions to or from the non-volatile memory 102 to perform operation to non-volatile memory 102, for example, read, program, or erase the non-volatile memory 102.

The non-volatile memory 102 preferably has one or more than one logical unit number (LUN), which can be selected/enabled by a chip enable (CE) signal. Each logical unit number (LUN) includes, for example, four planes, namely, planes PL1˜PL4. Each of the planes PL1˜PL4 includes, for example, 2048 blocks, namely, blocks Bk1˜Bkn, wherein k=1, 2, 3, 4, n=2048. Each of the blocks Bk1˜Bkn includes, for example, 1024 pages, namely, pages P1˜Pm, wherein m=1024. Each page can be controlled by a word line, and each word line can control more than one page. Each word line includes, for example, 16 KB cells (not shown). The cells can be quad level cells (QLC), triple level cells (TLC), multiple level cells (MLC), or single level cells (SLC). It should be noted that the present embodiment is for exemplary purpose only, and the amount of chips, planes, blocks, pages, word lines and cells can be designed and arranged according to actual needs.

The data storage apparatus 100 can further be coupled to a host (not shown). The host can output a data access instruction (for example, an instruction to read or write data) to the data storage apparatus 100 to access (read or write) user data of the data storage apparatus 100. For example, in response to the data access instruction outputted from the host, the memory controller 104 of the data storage apparatus 100 can read data from one or more than one physical address in the non-volatile memory 102. The host can be, for example, a personal computer, a mobile phone, a PC tablet, an on-board unit, or a navigation device.

Besides, the non-volatile memory 102 can store system information relevant to the data storage apparatus 100, for example, system specification, operating parameter, bad block information, block linking table, block attribute table (recording, for example, erase count or amount of effective pages), debugging information table (for example, SMART information table) and/or logical to physical (L2P) mapping table. The above data normally has a smaller data amount, for example, 30 KB, and the memory controller 104 continuously updates the system information.

For the efficiency of the data storage apparatus 100 to be maximized, during data (user data or system information) writing, the memory controller 104 normally writes data to the non-volatile memory 102 by performing an inter-leaving programming process. For example, data are simultaneously written to the blocks (pages) of all planes. For example, data are simultaneously written to the block B11 on the plane PL1, the block B21 on the plane PL2, the block B31 on the plane PL3, and the block B41 on the plane PL4 to achieve a higher data write speed.

It is true that writing user data to the blocks of all planes by performing an inter-leaving programming process can achieve the expected effect. However, writing user data to the blocks of all planes by performing an inter-leaving programming process may cause waste in storage space. In the above example, with a conventional inter-leaving programming process, 4 pages of 4 blocks on 4 planes can store 64 KB (4times of 16 KB) of data, but the system information only has 30 KB. Therefore, to perform the inter-leaving programming process, the memory controller 104 will form 34 KB of dummy data, and group 34 KB of dummy data and 30 KB of system information to form 64 KB of data, and further write the 64 KB of system information to the blocks of all planes by performing an inter-leaving programming process. Therefore, each time when an item of system information is updated/written, the non-volatile memory 102 will store 34 KB of dummy data, with the increasing of the update count of the system information, the non-volatile memory 102 will store a large amount of dummy data, and a large amount of storage space of the non-volatile memory 102 will be occupied. Thus, the memory controller 104 performs the write operation of the system information by using the operating method described below.

It should be noted that in order to simplify the descriptions, only components relevant to the disclosure are shown in FIG. 1. It should be understood that the implementation of the disclosure is not limited to the block diagram shown in FIG. 1.

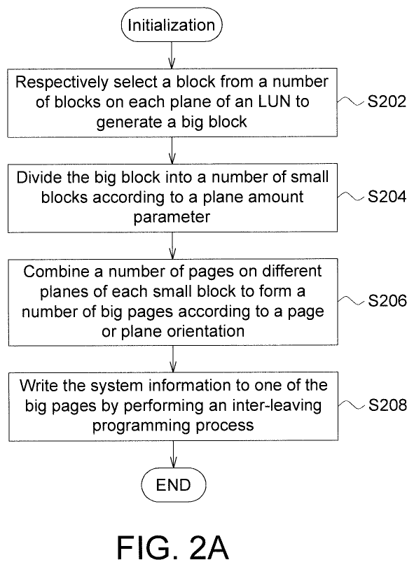

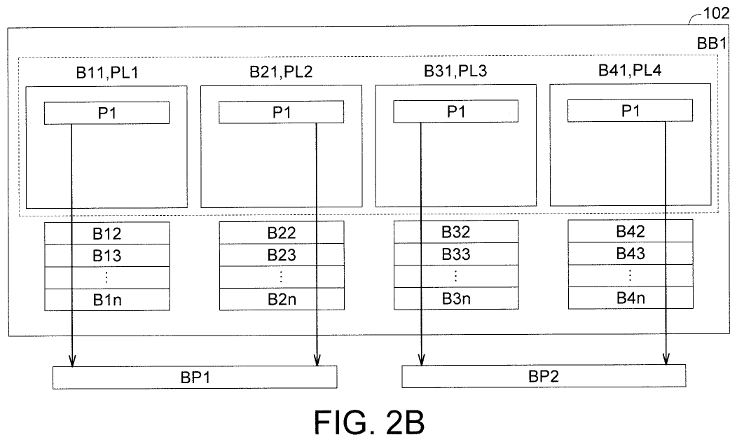

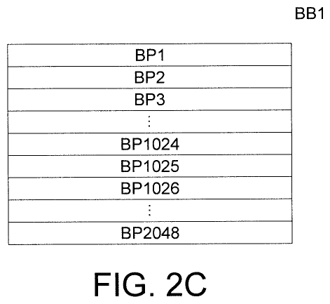

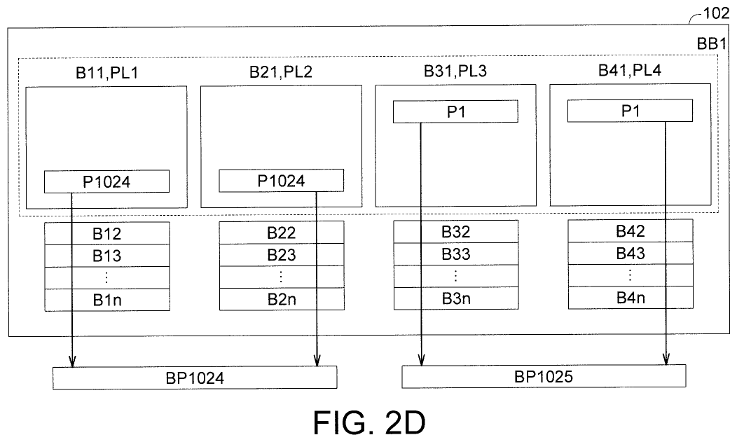

Referring to FIG. 2A, a flowchart of a system information programming method according to an embodiment of the disclosure is shown. Preferably, the system information programming method of the disclosure is performed by the memory controller 104. Also, the system information programming method of the disclosure can be performed by a host, which outputs an instruction to the data storage apparatus 100. The following descriptions are exemplified by the memory controller 104, but the disclosure is not limited thereto.

In step S202, a block is selected from the blocks on each plane of the LUN by the memory controller 104 to form a big block. The selected block is also referred as a member block which represents the block included in the big block. Refer to FIG. 2B. The memory controller 104 selects the blocks B11˜B41 on the planes PL1˜PL4 of the LUN of the non-volatile memory 102 to form a big block BB1, and the rest can be obtained by the same way. That is, the blocks B11˜B41 are member blocks of the big block BB1. Preferably, the memory controller 104 selects the blocks having the same block number from the planes PL1˜PL4 to form a big block. If the selected block is a bad block, the memory controller 104 can select another block (not bad block) from the same plane (that is, the plane on which the bad block is located) to replace the bad block. Preferably, the memory controller 104 records the block number (and the plane number) of each block of the big block BB.

In step S204, the big block is divided into a number of small blocks by the memory controller 104 according to a plane amount parameter. Let the plane amount parameter be exemplified by 2. The memory controller 104 divides the big block BB1 into 2 small blocks according to the plane amount parameter. The blocks B11˜B21 on the planes PL1˜PL2 are set as the first small block, and the blocks B31˜B41 on the planes PL3˜PL4 are set as the second small block. Also, for the blocks of the big block BB1, the memory controller 104 can set the blocks B11 and B31 on the planes PL1 and PL3 as the first small block, and set the blocks B21 and B41 on the planes PL2 and PL4 as the second small block, but the disclosure is not limited thereto.

In step S206, the pages on different planes of each small block are grouped by the memory controller 104 to form a number of big pages according to a page or plane orientation (for example, sequentially, but not limited thereto). FIG. 2B is a schematic diagram of big pages formed by sequentially grouping the pages on different planes of each small block by the memory controller 104 according to the plane orientation. In the above example, the memory controller 104 groups the page P1 on the planes PL1 and the page P1 on the plane PL2 of the first small block to form a big page BP1 (belonging to the big block BB1), then groups the page P1 on the planes PL3 and the page P1 on the plane PL4 of the second small block to form a big page BP2, then groups the page P2 on the plane PL1 and the page P2 on the plane PL2 of the first small block to form a big page BP3, and the rest can be obtained by the same way. At last, 2048 big pages can be formed. The big page numbers respectively are BP1˜BP2028 as indicated in FIG. 2C. Preferably, the memory controller 104 groups the pages, which are on the planes PL1˜PL2 of each small block and have the same page number to form a big page. When one of the pages cannot be used, the memory controller 104 groups the pages, which are on the planes PL1˜PL2 or PL3˜PL4 of the small blocks but have different page numbers, to form a big page or skip this big page (the total amount of big pages will be 1 less than the expected amount).

FIG. 2D is a schematic diagram of big pages formed by sequentially grouping the pages on different planes of each small block by the memory controller 104 according to the page orientation. In the above example, the memory controller 104 groups the page P1 on the planes PL1 and the pages P1 on the plane PL2 of the first small block to form a big page BP1, groups the page P2 on the plane PL1 and the page P2 on the plane PL2 of the first small block to form a big page BP2, and the rest can be obtained by the same way. After all of the pages of the first small block are all grouped to form the big pages, groups the page P1 on the plane PL3 and the page P1 on the plane PL4 of the second small block to form a big page BP1025, groups the page P2 on the plane PL3 and the page P2 on the plane PL4 of the second small block to form a big page BP1026, and the rest can be obtained by the same way. At last, 2048 big pages can also be formed.

In step S208, system information is written to one of the big pages by the memory controller 104 performing an inter-leaving programming process. After the big pages are formed, the memory controller 104 can use the big pages to store the system information. Given that the data storage capacity of each big page is 32 KB and that the system information is 30 KB, the memory controller 104 forms only 2 KB of dummy data. After 2 KB of dummy data and 30 KB of system information are grouped to form 32 KB of data, the system information is written to a big page, for example, the big page BP1, by performing an inter-leaving programming process. When the system information is updated, the updated system information is written to the big page BP2 by performing an inter-leaving programming process. In order to achieve the purpose of protecting the system information, the memory controller 104 preferably writes the system information to the big pages in a non-default mode, for example, the SLC mode. In the non-default mode, the data storage capacity of one single word line is less than the data storage capacity in the default mode, such as TLC or QLC mode. When the system information programming method of the disclosure is performed by a host, the host will output an instruction to instruct the memory controller 104 to write the system information to one of the big pages by performing an inter-leaving programming process.

When a conventional system information programming method is used, the memory controller 104 can only write an item of system information to the blocks of all planes by performing an inter-leaving programming process. When the system information programming method of the disclosure is used, the memory controller 104 can write two items of system information to the blocks of all planes by performing an inter-leaving programming process. In other words, a half of data storage capacity of the system information can be saved.

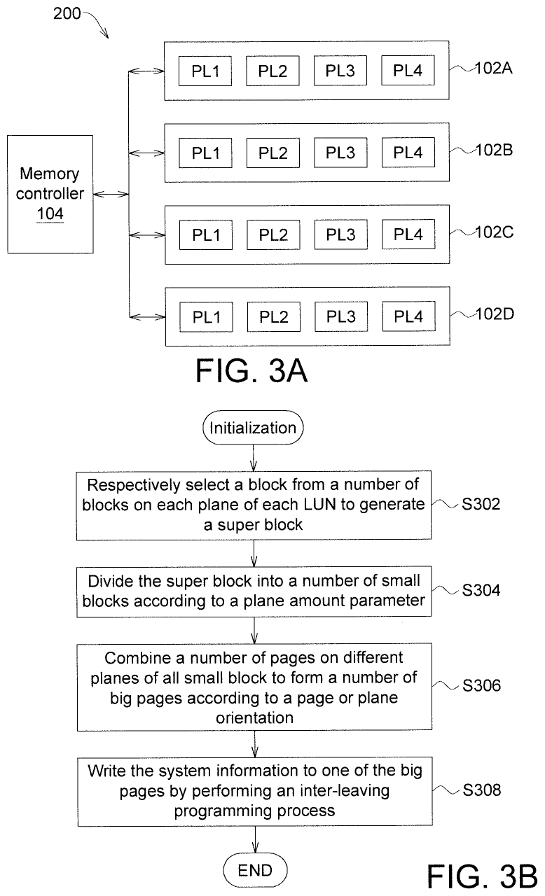

Referring to FIG. 3A, a block diagram of a data storage apparatus according to another embodiment of the disclosure is shown. The non-volatile memory of the data storage apparatus 200 may include 4 LUNs 102A˜102D and the memory controller 104. Each of the LUNs 102A˜102D has a structure identical to or similar with the structure of the non-volatile memory 102, and each of the LUNs 102A˜102D has an independent channel connected to the memory controller 104. The memory controller 104 can simultaneously enable the LUNs 102A˜102D with the same or different chip enabling signals to access data. In theory, the memory controller 104 can simultaneously access the LUNs 102A˜102D. Thus, the data throughput of the data storage apparatus 200 is 4 times of the data storage apparatus 100.

Referring to FIG. 3B, a flowchart of a system information programming method according to another embodiment of the disclosure is shown. In step S302, a block is respectively selected from the blocks on each plane of each LUN by the memory controller 104 to form a super block. The selected block is also referred as a member block which represents the block included in the super block (or the big block). Like step S202, the blocks B11˜B41 on the planes PL1˜PL4 of each of the LUNs 102A˜102D are selected by the memory controller 104 to form a big block, which is also referred as a super block SB1, and the rest can be obtained by the same way. Preferably, the memory controller 104 selects the blocks, which are on the planes PL1˜PL4 of the LUNs 102A˜102D and have the same block number, to form a super block. If the selected block is a bad block, the memory controller 104 can select another block (not bad block) from the same plane (that is, the plane on which the bad block is located) to replace the bad block. Preferably, the memory controller 104 records the block number, the plane number, and the LUN of each block of the super block or a combination thereof.

In step S304, the super block is divided into a number of small blocks by the memory controller 104 according to a plane amount parameter. Let the plane amount parameter be exemplified by 2. For the blocks of the super block SB1, the memory controller 104 can set the blocks B11˜B21 on the planes PL1˜PL2 of the LUN 102A as the first small block, set the blocks B31˜B41 on the planes PL3˜PL4 of the LUN 102A as the second small block, set the blocks B31˜B41 on the planes PL3˜PL4 of the LUN 102D as the 8-th small block. Also, for the blocks of the super block SB1, the memory controller 104 can set the blocks B11 and B31 on the planes PL1 and PL3 of the LUN 102A as the first small block and set the blocks B21 and B41 on the planes PL2 and PL4 as the second small block, but the disclosure is not limited thereto.

In step S306, the pages on different planes of all small blocks are grouped by the memory controller 104 according to a page or plane orientation (for example, sequentially) to form a number of big pages. When it is according to the plane orientation, the memory controller 104 groups the page P1 on the plane PL1 and the page P1 on the plane PL2 of the first small block to form a big page BP1, groups the page P1 on the plane PL3 and the page P1 on the plane PL4 of the second small block to form a big page BP2; the memory controller 104 groups the page P1 on the plane PL1 and the page P1 on the plane PL2 of the third small block to form a big page BP3, and the rest can be obtained by the same way. At last, 8192 big pages are formed, and the big page numbers respectively are BP1˜BP8192. In another embodiment, when it is according to the page orientation, the memory controller 104 groups the page P1 on the plane PL1 and the page P1 on the plane PL2 of the first small block to form a big page BP1, groups the page P2 on the planes PL1 and the page P2 on the plane PL2 of the first small block to form a big page BP2, and the rest can be obtained by the same way. After the pages of the first small block are all grouped to form the big pages, the memory controller 104 then groups the page P1 on the plane PL3 and the page P1 on the plane PL4 of the second small block to form a big page BP1025, groups the page P2 on the plane PL3 and the page P2 on the plane PL4 of the second small block to form a big page BP1026. By the same way, 8192 big pages can also be formed.

In step S308, the system information is written to one of the big pages by the memory controller 104 performing an inter-leaving programming process. After the big pages are formed, the memory controller 104 can use the big pages to store the system information. Given that the data storage capacity of each big page is 32 KB and that the system information is 30 KB, the memory controller 104 forms only 2 KB of dummy data. After 2 KB of dummy data and 30 KB of system information are grouped to form 32 KB of data, the system information is written to a big page, for example, the big page BP1, by performing an inter-leaving programming process. When the system information is updated, the updated system information is written to the big page BP2 by performing an inter-leaving programming process. When a conventional system information programming method is used, the memory controller 104 can only write an item of system information to the blocks of all planes by performing an inter-leaving programming process. In comparison, when the system information programming method of the disclosure is used, the memory controller 104 can write 8 items of system information to the blocks of all planes by performing an inter-leaving programming process. In other words, ⅞ of the data storage capacity of the system information can be saved.

The data storage apparatus and the system information programming method of the disclosure effectively avoid writing too many dummy data to the non-volatile memory, hence increasing the use efficiency of internal storage space of the non-volatile memory.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data storage apparatus, comprising:
a non-volatile memory, comprising a logical unit number (LUN), wherein the LUN comprises a plurality of planes, and each of the planes comprises a plurality of blocks, and each of the blocks comprises a plurality of pages; and
a memory controller coupled to the memory and configured to select a plurality of member blocks from the blocks on each of the planes of the LUN to form a big block, divide the big block into a plurality of small blocks according to a plane amount parameter, group the pages of each small block on different planes to form a plurality of big pages according to a page or plane orientation, and write a system information to one of the big pages by performing an inter-leaving programming process.

2. The data storage apparatus according to claim 1, wherein the member blocks have the same block number.

3. The data storage apparatus according to claim 1, wherein when grouping the pages of each small block on different planes to form the big pages according to a page or plane orientation, the memory controller sequentially groups the pages of each small block on different planes to form the big pages according to the page or plane orientation.

4. The programming method according to claim 1, wherein the inter-leaving programming process is performed in a non-default mode to write the system information to one of the big pages.

5. The programming method according to claim 4, wherein the non-default mode is a SLC mode.

6. A data storage apparatus, comprising:
a non-volatile memory, comprising a plurality of logical unit numbers (LUNs) each comprising a plurality of planes, wherein each plane comprises a plurality of blocks, and each block comprises a plurality of pages; and
a memory controller coupled to the memory and configured to select a plurality of member blocks from the blocks on each of the planes of the LUNs to form a super block, divide the super block into a plurality of small blocks according to a plane amount parameter, group the pages of each small block on different planes to form a plurality of big pages according to a page or plane orientation, and write a system information to one of the big pages by performing an inter-leaving programming process.

7. The data storage apparatus according to claim 6, wherein the member blocks have the same block number.

8. The data storage apparatus according to claim 6, wherein when grouping the pages of each small block on different planes to form the big pages according to a page or plane orientation, the memory controller sequentially groups the pages of each small block on different planes to form the big pages according to the page or plane orientation.

9. The programming method according to claim 6, wherein the inter-leaving programming process is performed in a non-default mode to write the system information to one of the big pages.

10. The programming method according to claim 9, wherein the non-default mode is a SLC mode.

11. A system information programming method for a data storage apparatus, comprising:
respectively selecting a member block from a plurality of blocks on each plane of a logical unit number (LUN) of a non-volatile memory to form a big block;
dividing the big block into a plurality of small blocks according to a plane amount parameter;
grouping a plurality of pages of each small block on different planes to form a plurality of big pages according to a page or plane orientation; and
writing a system information to one of the big pages by performing an inter-leaving programming process.

12. The programming method according to claim 11, wherein the member blocks have the same block number.

13. The programming method according to claim 11, wherein in the step of grouping the pages of each small block on different planes to form the big pages according to a page or plane orientation, the memory controller sequentially groups the pages of each small block on different planes to form the big pages according to the page or plane orientation.

14. The programming method according to claim 11, wherein the plane amount parameter is 2.

15. The programming method according to claim 11, wherein the inter-leaving programming process is performed in a non-default mode to write the system information to one of the big pages.

16. The programming method according to claim 11, wherein the non-default mode is a SLC mode.

17. A system information programming method for a data storage apparatus, comprising:
respectively selecting a member block from a plurality of blocks on each plane of a plurality of LUNs of the non-volatile memory to form a super block;
dividing the super block into a plurality of small blocks according to a plane amount parameter;
grouping a plurality of pages of each small block on different planes to form a plurality of big pages according to a page or plane orientation; and
writing a system information to one of the big pages by performing an inter-leaving programming process.

18. The programming method according to claim 17, wherein the member blocks have the same block number.

19. The programming method according to claim 17, wherein in the step of grouping the pages of each small block on different planes to form the big pages according to a page or plane orientation, the memory controller sequentially groups the pages of each small block on different planes to form the big pages according to the page or plane orientation.

20. The programming method according to claim 17, wherein the plane amount parameter is 2.

21. The programming method according to claim 17, wherein the inter-leaving programming process is performed in a non-default mode to write the system information to one of the big pages.

22. The programming method according to claim 21, wherein the non-default mode is a SLC mode.
